(19) United States
(12) Patent Application Publication
(10) Pub. No.: US 2025/0075988 A1
(43) Pub. Date: Mar. 6, 2025

(54) ACTIVE THERMAL SWITCH

(71) Applicant: Lunar Outpost EU, Foetz (LU)

(72) Inventors: Andrew Josef Gemer, Lafayette, CO (US); Justin Cyrus, Golden, CO (US); Julian Cyrus, Golden, CO (US); Peter Wilson, Golden, CO (US); Tobias Flecht, Luxembourg (LU)

(21) Appl. No.: 18/821,513

(22) Filed: Aug. 30, 2024

Related U.S. Application Data
(60) Provisional application No. 63/579,794, filed on Aug. 30, 2023.

(51) Int. Cl. F28F 13/00; F28F 27/00

(52) U.S. Cl. CPC F28F 13/00; F28F 27/00; F28F 2013/008; F28F 2245/06

(57) ABSTRACT

An active thermal switch assembly according to aspects described herein may include a hot plate, a cold plate, and an actuator. The actuator may cause the hot plate and the cold plate to come into mechanical contact, thereby achieving a closed state for the active thermal switch and facilitating conductive heat transfer between the two plates. Convective/radiative heat transfer may have little effect as compared to conductive heat transfer (e.g., as may be the case in environments having reduced or no atmospheric pressure), such that operating the actuator to introduce a gap between the hot plate and the cold plate (thus achieving an “open” state) substantially reduces conductive heat transfer between the hot and cold plates accordingly. Controlling the separation distance between the hot plate and cold plate may also be used as a method to modulate the thermal radiation between the two surfaces.

### CROSS REFERENCE TO RELATED APPLICATION

The present application claims priority to U.S. Provisional Patent Application No. 63/579,794, entitled “ACTIVE THERMAL SWITCH,” and filed on Aug. 30, 2023, the entire disclosure of which is expressly incorporated by reference herein for all purposes.

### BACKGROUND

Vehicles, electronic devices, and other hardware have a range of operating temperatures, outside of which, unexpected or unintended operation, or even failure, may result. However, even in instances where a thermal management system is used to manage the thermal properties of such hardware (e.g., to heat or cool one or more systems of the vehicle), thermal conditions of an environment may change, such that a configuration of the thermal system that is effective under a first set of thermal conditions may no longer be effective or may even be detrimental under a second set of thermal conditions.

It is with respect to these and other general considerations that embodiments have been described. Also, although relatively specific problems have been discussed, it should be understood that the embodiments should not be limited to solving the specific problems identified in the background.

### SUMMARY

An active thermal switch assembly according to aspects described herein may include a hot plate, a cold plate, and an actuator. The actuator may cause the hot plate and the cold plate to come into mechanical contact, thereby achieving a closed state for the active thermal switch and facilitating conductive heat transfer between the two plates. Convective/radiative heat transfer may have little effect as compared to conductive heat transfer (e.g., as may be the case in environments having reduced or no atmospheric pressure), such that operating the actuator to introduce a gap between the hot plate and the cold plate (thus achieving an “open” state) substantially reduces conductive heat transfer between the hot and cold plates accordingly. Controlling the separation distance between the hot plate and cold plate may also be used as a method to modulate the thermal radiation between the two surfaces.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a conceptual diagram of an example vehicle with which an active thermal switch may be used according to aspects described herein.

FIG. 2 illustrates a conceptual diagram of a system that includes an example thermal switch assembly according to aspects described herein.

FIG. 3A illustrates an exploded perspective view of an example thermal switch assembly according to aspects described herein.

FIG. 3B illustrates a perspective view of the example thermal switch assembly of FIG. 3A.

FIG. 4A illustrates a front perspective view of another example thermal switch assembly according to aspects described herein.

FIG. 4B illustrates a front perspective cross section view of the example thermal switch assembly of FIG. 4A.

FIG. 4C illustrates a rear perspective view of the example thermal switch assembly of FIG. 4A.

FIG. 5A illustrates a perspective view of another example thermal switch assembly according to aspects described herein.

FIG. 5B illustrates a cross section view of the example thermal switch assembly of FIG. 5A.

FIG. 5C illustrates another cross section view of the example thermal switch assembly of FIG. 5A.

FIG. 6 illustrates an overview of an example method for controlling a thermal switch assembly according to aspects described herein.

FIG. 7 illustrates an example of a suitable computing environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Some electrical and mechanical hardware operate in environments having a high degree of temperature variability. This is especially true for hardware operating in space, on the Moon, or on Mars, among other examples. While a thermal management system (e.g., including one or more heat pipes, radiators, solar concentrators, thermal reservoirs, and/or heat-producing elements) may manage thermal properties of such hardware (e.g., to heat and/or cool the hardware), a configuration of the thermal management system that is effective for a first set of thermal conditions may not be effective or may even be detrimental for alternative sets of thermal conditions. This is especially relevant for hardware operating in rapidly-changing thermal environments (e.g. a lunar rover traversing through sunlight and shadow on the lunar surface).

For example, under the first set of conditions, the hardware may be subjected to solar radiation and/or may itself be generating heat, such that excess heat is expelled via a radiator of the thermal management system. However, under the second set of conditions, the hardware may be shielded from solar radiation (e.g., as may be the case during operation in shadow or the lunar night), such that the radiator causes the hardware to lose heat at a rate that is greater than would be radiated from the hardware in the absence of the radiator (e.g., as a result of the surface area of the radiator, which can be optimized to reject a certain amount of heat during sunlit conditions).

Thus, while the thermal management system may extend operation of the hardware in certain challenging conditions (e.g., by reducing the amount of excess heat to which such hardware is exposed), the same thermal management system may have the opposite effect of reducing hardware longevity in other conditions (e.g., by permitting heat rejection in a cold environment). It will be appreciated that such conditions are provided as examples and, in other examples, a thermal management system may facilitate increased heat transfer from the environment to hardware to warm the hardware in a first set of conditions, which may cause the hardware to overheat in a second set of conditions.

Accordingly, aspects of the present disclosure relate to an active thermal switch, such that a thermal management system may be reconfigured in response to changing environmental conditions and/or thermal properties of hardware associated therewith. For example, an active thermal switch may switchably couple a heat source and a heat sink, such that heat transfer from the heat source to the heat sink may be enabled, disabled, or otherwise controlled (e.g., thereby managing an intended degree of heat transfer between the heat source and the heat sink).

As used herein, a heat source includes hardware from which heat is to be transferred, while a heat sink includes hardware to which the heat is to be transferred. It will be appreciated that a heat source in a first set of conditions may instead be a heat sink in a second set of conditions. For example, a radiator (acting as a heat sink) may be used to dissipate excess heat from a hardware component (thus acting as a heat source), while heat absorbed by the radiator (thus instead acting as a heat source) may be used to warm the hardware component (thus instead acting as a heat sink).

An active thermal switch assembly according to aspects described herein may include a hot plate, a cold plate, and an actuator. In examples, the hot plate is mechanically coupled to a heat source, while the cold plate is mechanically coupled to a heat sink. Similar to a heat source and a heat sink, in some instances a hot plate may instead act as a cold plate in other instances (e.g., and is thus coupled to a heat sink), and vice versa. The actuator may cause the hot plate and the cold plate to come into mechanical contact (which may be referred to as a “closed” state), thereby facilitating conductive heat transfer between the two plates. Other types of heat transfer (e.g., convective and/or radiative heat transfer) may have little effect as compared to conductive heat transfer (e.g., as may be the case in environments having reduced or no atmospheric pressure), such that operating the actuator to introduce a gap between the hot plate and the cold plate (an “open” state) substantially reduces heat transfer between the hot and cold plates accordingly. Controlling the separation distance between the hot plate and cold plate may also be used as a method to modulate the thermal radiation between the two surfaces.

As compared to passive thermal switches (e.g., based on phase change materials and/or thermal expansion), aspects described herein enable active control of heat transfer within a system and/or across systems, such that the thermal state of such systems may be dynamically managed in response to changing environment conditions, system behaviors, and/or mission objectives, among other benefits.

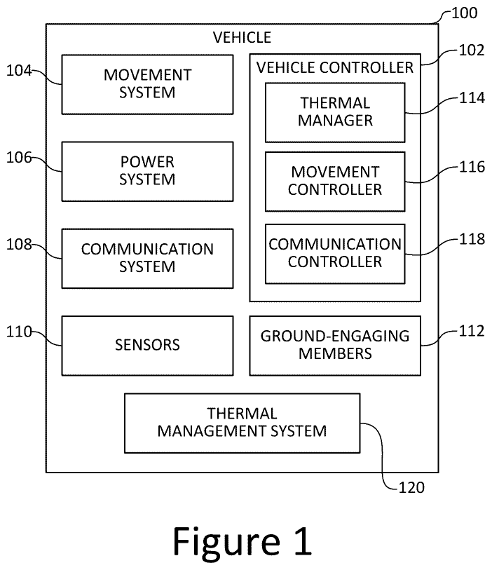

FIG. 1 illustrates a conceptual diagram of an example vehicle 100 with which an active thermal switch may be used according to aspects described herein. As noted above, the disclosed aspects may similarly be implemented by any of a variety of other types of hardware in other examples. As illustrated, vehicle 100 includes vehicle controller 102, movement system 104, power system 106, communication system 108, sensors 110, ground-engaging members 112, and thermal management system 120.

It will be appreciated that vehicle 100 may be any of a variety of vehicles, including, but not limited to, a rover, a robot, a launch vehicle, a lander, or a satellite. For instance, the disclosed active thermal switch assembly can be used in a configuration that dissipates heat when a satellite payload is powered on, while the active thermal switch assembly is instead used in a configuration that conserves heat when the satellite payload is powered off. Vehicle 100 is illustrated as further including one or more ground-engaging members 112. Example ground-engaging members include, but are not limited to, wheels or tracks. In examples, vehicle 100 may be remotely controlled (e.g., via communication system 108) and/or may be autonomously controlled (e.g., as may be affected by vehicle controller 102).

Movement system 104 may include a prime mover (e.g., an electric motor or an internal combustion engine) to power ground-engaging members 112, as well as a steering system, which may control a steering angle of one or more ground-engaging members 112 and/or may cause ground-engaging members 112 to be powered differently to achieve rotation about an axis. In examples, movement controller 116 of vehicle controller 102 controls movement system 104 to affect movement of vehicle 100 accordingly. For example, movement controller 116 may cause movement system 104 to propel vehicle 100 forward, backward, or in any of a variety of other directions. Movement controller 116 may control movement system 104 according to one or more commands that are received by vehicle 100 (e.g., via communication system 108) from a remote device (not pictured) and/or may control movement system 104 at least partially automatically (e.g., based on data from sensors 110; according to the disclosed environment-based thermal management aspects).

Power system 106 may provide electrical power to movement system 104, communication system 108, and/or vehicle controller 102, among other examples. In examples, power system 106 includes a battery and a solar panel with which to recharge the battery. As another example, power system 106 may include a radioisotope thermoelectric generator. Thus, it will be appreciated that vehicle 100 may include any of a variety of power sources and, similarly, any of a variety of movement systems may be used to propel vehicle 100 accordingly.

Communication system 108 may include any of a variety of communication technologies to provide wired and/or wireless communication for vehicle 100. Communication controller 118 of vehicle controller 102 may control communication system 108, thereby enabling communication to and/or from vehicle 100. For example, communication controller 118 may configure one or more radios of communication system 108 and/or may establish a connection with one or more remote devices (not pictured).

Sensors 110 of vehicle 100 may include any of a variety of sensors, including, but not limited to, image capture devices (e.g., visible light and/or infrared cameras), light sensors, proximity sensors, temperature sensors (e.g., thermocouples or thermistors), three-dimensional mapping sensors (e.g., using multiple image capture devices or a light detection and ranging (LIDAR) system), and/or chemical composition sensors, among other examples.

In examples, sensors 110 includes one or more temperature sensors that are used to monitor a temperature corresponding to hardware of vehicle 100 (e.g., relating to movement system 104, power system 106, and/or communication system 108, among other examples). For example, sensors 110 includes a first temperature sensor associated with a heat source and a second temperature sensor associated with a heat sink. In some instances, a thermal switch assembly includes one or more temperature sensors (e.g., associated with a hot plate and/or a cold plate), among other examples. Such temperature sensors may be used (e.g., by thermal manager 114) to determine whether to connect or disconnect a heat sink/heat source, to determine the degree to which heat transfer is to be permitted, and/or to monitor the transfer of heat between one or more components and/or across the thermal switch, among other examples.

Sensors 110 may include one or more sensors that are used to determine a condition of the environment in which the vehicle is operating. For example, an outward-facing temperature sensor may be used or an infrared camera may be used to determine an environment temperature and/or temperature gradient. It will therefore be appreciated that any of a variety of additional or alternative sensors may be used. For example, an infrared camera may additionally or alternatively be used to evaluate the heat of various components of vehicle 100 according to aspects described herein.

Vehicle controller 102 is illustrated as further comprising thermal manager 114. In examples, thermal manager 114 evaluates a state for hardware of one or more systems of vehicle 100 (e.g., movement system 104, power system 106, and/or communication system 108) to determine whether to change a configuration of thermal management system 120 (e.g., as may include one or more heat pipes, radiators, solar concentrators, thermal reservoirs, and/or heat-producing elements).

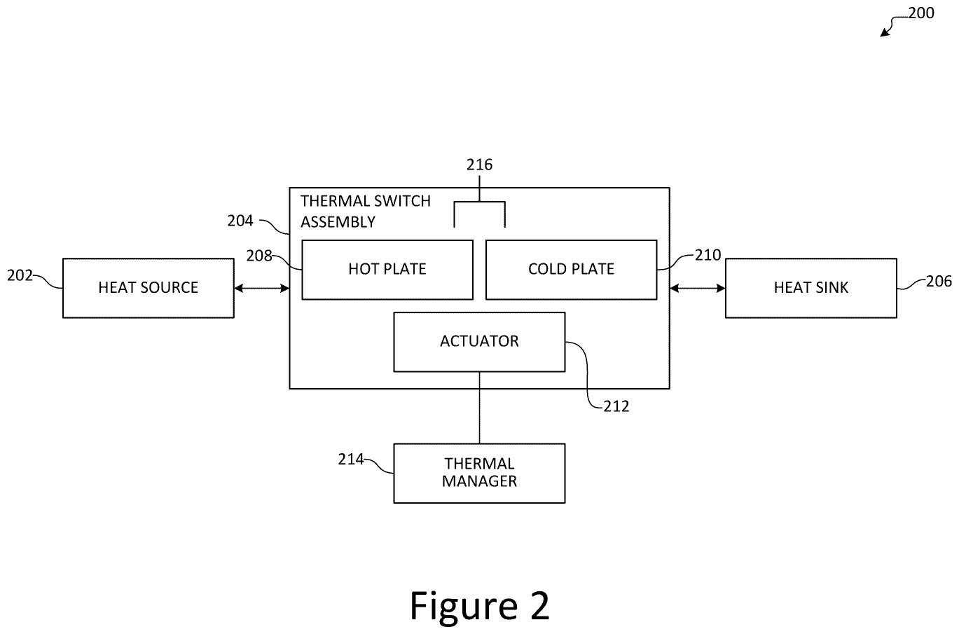

For example, thermal manager 114 may determine that hardware of vehicle 100 is too hot or too cold (e.g., as compared to a predetermined threshold or according to a set of rules), such that thermal manager 114 may provide an indication to one or more active thermal switches (e.g., examples of which are described below in reference to FIGS. 2, 3A-3B, and 4A-4C) of thermal management system 120 accordingly. As an example, an active thermal switch of thermal management system 120 may be actuated to cause a hot plate and a cold plate of the active thermal switch to come into contact (e.g., thereby increasing heat transfer) or to become separated (e.g., thereby decreasing heat transfer), among other examples. For example, a thermal reservoir of thermal management system 120 may store heat that may be selectively extracted by coupling/decoupling hardware to the thermal reservoir using the active thermal switch. In another example, thermal switches may be used to control conduction paths to radiators on the sides of a vehicle, altering which radiator is coupled to the heat source as a vehicle turns and opposite sides of the vehicle are selectively sunlit/shaded.

In some examples, thermal manager 114 may additionally configure any of a variety of other components of thermal management system 120. For example, thermal manager 114 may power on, power off, or change the intensity of a heat-producing element (e.g., as may be coupled to a hot plate of the active thermal switch). As another example, thermal manager 114 may communicate with movement controller 116 to cause vehicle 100 to reposition itself (e.g., thereby affecting the degree to which environmental conditions facilitate heat transfer via the active thermal switch. It will therefore be appreciated that thermal manager 114 may perform any of a variety of operations in association with a thermal switch of thermal management system 120 according to aspects described herein. Further, an active thermal switch may be used to facilitate heat transfer between systems of vehicle 100 (e.g., in addition to or as an alternative to heat dissipation and/or heat capture via thermal management system 200). In another example, an active thermal switch may be used to facilitate heat transfer between a vehicle and another, separate heat source or sink, such as a heat-producing or heat-storing piece of hardware, or a radiating piece of hardware, enabling actively controlled transfer of heat into or out of the vehicle itself.

Thermal manager 114 may collect telemetry data associated with the disclosed thermal management techniques, which may be stored by vehicle controller 102 and/or transmitted to a remote device (e.g., via communication system 108). For example, thermal manager 114 may store an estimated thermal effect and an observed thermal effect (e.g., as may be determined via sensors 110) as telemetry data. Such telemetry data may be used to generate a new model or improve an existing model for modeling a thermal effect of increasing or restricting thermal transfer via one or more active thermal switches based on associated environmental conditions. Thus, the predictive capability of thermal manager 114 may improve as additional telemetry data is generated for a variety of scenarios, environments, and/or environmental features therein.

While example processing is described above with respect to thermal manager 114, it will be appreciated that at least a part of such processing may be performed by a remote computing device in other examples. Similarly, while examples described herein are in the context of autonomous thermal management, it will be appreciated that similar techniques may be used to provide an indication as to an identified state corresponding to a vehicle system and/or any of a variety of hardware of the vehicle, such that a manual vehicle operator may use the indication to provide an instruction to reconfigure aspects of thermal management system 120 (e.g., via one or more active thermal switches) accordingly. In examples, aspects of sensors 110 and/or thermal manager 114 and/or thermal management system 120 are similar to those disclosed in U.S. patent application Ser. No. 18/048,020, entitled “ENVIRONMENT-BASED THERMAL MANAGEMENT,” and filed on Oct. 19, 2022, the entirety of which is incorporated herein by reference for all purposes.

FIG. 2 illustrates a conceptual diagram of system 200 that includes example thermal switch assembly 204 according to aspects described herein. As illustrated, system 200 includes heat source 202, thermal switch assembly 204, heat sink 206, and thermal manager 214. Aspects of thermal manager 214 may be similar to those discussed above with respect to thermal manager 114 in FIG. 1 and are therefore not necessarily redescribed in detail below.

Heat source 202 and heat sink 206 may each be any of a variety of hardware, including, but not limited to, hardware of a movement system (e.g., movement system 104 in FIG. 1), of a power system (e.g., power system 106), of a communication system (e.g., communication system 108), and/or of a thermal management system (e.g., thermal management system 120). As noted above, thermal switch assembly 204 may be used to control thermal flow between a system and hardware of a thermal management system (e.g., a radiator, a solar concentrator, or a heat-producing element) or may be used to control thermal flow between hardware within or across any of a variety of systems, among other examples.

Hot plate 208 and cold plate 210 may each comprise a metal plate. At least a portion of hot plate 208 and cold plate 210 may be a material that has comparatively high thermal conductivity (e.g., aluminum or copper). In examples, at least a portion of such a metal plate is electroplated or otherwise coated with a coating that improves thermal conductivity and/or reduces emissivity. For example, a silver or a gold coating may be used to coat respective regions of hot plate 208 and cold plate 210 at which the plates contact each other in a closed state and/or via which radiative heat transfer would occur between the plates when thermal switch assembly 204 is in an open state. As another example, hot plate 208 and cold plate 210 may each include a surface preparation that increases thermal conductivity when thermal switch assembly 204 is in a closed state. For instance, each surface may be prepared to have a comparatively increased smoothness, thereby reducing thermal resistance between plates 208 and 210. Thus, emissivity may be reduced and/or conductivity may be increased through these and/or any of a variety of other techniques.

As illustrated, thermal switch assembly 204 further comprises actuator 212. Any of a variety of actuators may be used, including, but not limited to, piezoelectric actuators, linear actuators, lead/ball screw actuators, mechanical cam actuators, and/or a chain and sprocket assembly, among other examples. Thermal switch assembly 204 may be designed to either fail open or fail closed in the event of a failure (e.g., resulting from loss of power, mechanical wear, or one or more seized components). For example, a preload mechanism (not pictured) may be used to place preload on hot plate 208 and/or cold plate 210 that is overcome by actuator 212 in operation (e.g., to move thermal switch assembly 204 from a closed state to an open state, or vice versa). Example preload mechanisms include, but are not limited to, extension springs, compression springs, compliant mechanisms, preload from non-backdrivable lead screws, and/or preload from piezoelectric actuation force, among other examples. Further, while system 200 is illustrated as including a single actuator 212, it will be appreciated that, in other examples, multiple similar or different actuators may be used, thereby increasing failure resistance.

In examples, a thermally insulative material is used to separate actuator 212 from hot plate 208 and/or cold plate 210, thereby reducing conduction to actuator 212 (and thus conduction across thermal switch assembly 204). Similarly, hot plate 208, cold plate 210, and actuator 212 may be disposed within a housing of thermal switch assembly 204, and may be fastened or otherwise mechanically coupled to thermal switch assembly using one or more materials that reduce thermal conductivity. For instance, nylon or polyether ether ketone (PEEK) fasteners may be used, insulation may be placed between hot plate 208, cold plate 210, and the housing, and/or a coating may be used to reduce emissivity within the housing. Other examples of insulating materials include, but are not limited to, fiberglass (e.g., FR4 or G-10), Vespel SP-1, or PEEK. It will be appreciated that thermal switch assembly 204 may be designed for a variety of operating temperatures. For instance, a lower temperature thermal switch assembly may use plastic and/or aluminum parts, while a higher temperature thermal switch assembly may use a steel alloy (e.g., Inconel) or other material having comparatively high temperature resistance.

In operation, thermal manager 214 controls actuator 212 to open or close thermal switch assembly 204. As illustrated, thermal switch assembly 204 is in an open configuration, such that gap 216 exists between hot plate 208 and cold plate 210. As noted above, radiative heat transfer between hot plate 208 and cold plate 210 (e.g., across gap 216) may result in substantially reduced heat transfer as compared to conductive heat when hot plate 208 and cold plate 210 are in contact. In examples, thermal switch assembly 204 includes one or more temperature sensors (not pictured), which are used to control actuation of thermal switch assembly 204 according to aspects described herein.

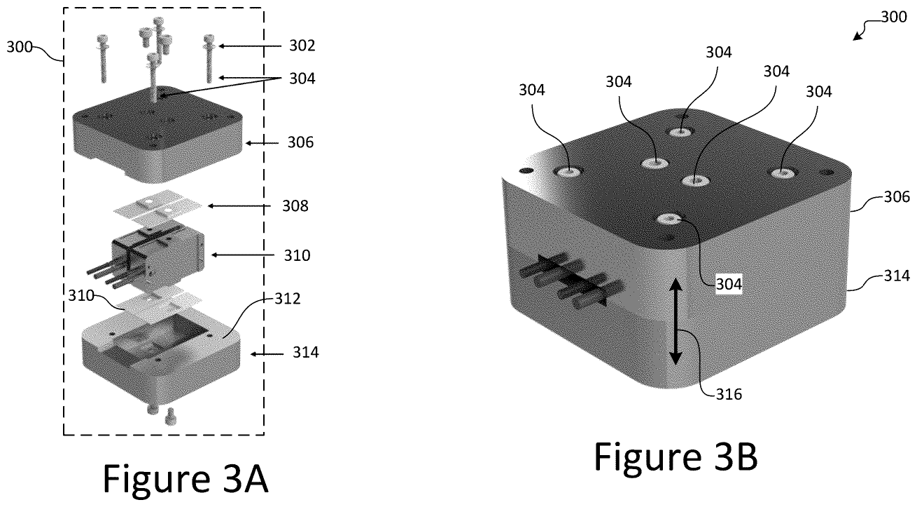

FIGS. 3A-3B illustrate an example thermal switch assembly 300 according to aspects described herein. As illustrated, thermal switch assembly 300 includes plate 306, actuator 310, and plate 314. Aspects of plates 306 and 314 may be similar to those discussed above with respect to plates 208 and 210 in FIG. 2 and are therefore not necessarily redescribed in detail below.

As illustrated, plate 314 includes coating 312 (and plate 306 may similarly include such a coating), which may reduce the emissivity of the surfaces of plate 306 and 314, thereby reducing radiative heat transfer between the respective surfaces of plates 306 and 314 when thermal switch assembly 300 is in an open configuration. Similarly, fasteners 304 may be a thermally insulative material, thereby reducing conductive heat transfer across thermal switch assembly 300 when in the open configuration.

As illustrated, thermal switch assembly further includes preload spring washers 302, which act as a preload mechanism and therefore cause thermal switch assembly 300 to have a default closed state (such that thermal switch assembly 300 would similarly fail closed). As such, in operation, piezoelectric actuators 310 are used to overcome the preload force provided by preload spring washers 302 and thus open thermal switch assembly 300 accordingly.

Piezoelectric actuators 310 are controlled via voltage application (e.g., by a thermal manager, such as thermal manager 114 or thermal manager 214 in FIG. 1 or 2, respectively) and function electrically as a capacitor. When piezoelectric actuators 310 are extended, there may be a small amount of leakage current (e.g., as may resemble a capacitor that has reached a steady voltage differential). Accordingly, during extended operation (e.g., during the lunar night) this leakage current may incur a relatively small continuous power draw as compared to the power generation capabilities of a vehicle (e.g., vehicle 100 in FIG. 1). Further, during actuation (e.g., when transitioning from the closed state to the open state), piezoelectric actuators 310 may have increased power consumption. However, the relatively quick actuation time of piezoelectric actuators 310 may ensure a minimal impact on the overall efficiency and electrical performance of the system in which thermal switch assembly 300 is used. Additionally, given the repeatability of piezoelectric actuators 310, thermal switch assembly 300 will be able to function for many cycles with a relatively small impact on actuation performance.

Thus, to open thermal switch assembly 300, a voltage may be applied to induce actuation of piezoelectric actuators 310 and push against the springs, thereby separating plates 306 and 314. In examples, one or both piezoelectric actuators 310 are used. Arrows 316 are provided to illustrate the direction along which plates 306 and 314 move when actuated by piezoelectric actuators 310 according to aspects described herein. While two piezoelectric actuators 310 are illustrated, it will be appreciated that additional or fewer piezoelectric actuators may be used in other examples. For example, two actuators may be used to provide redundancy.

Piezoelectric actuators 310 are illustrated as being insulated from plates 306 and 314 by thermally insulative material 308, (e.g., polyimide aerogel), which thus separates piezoelectric actuators 310 from metal plates 306 and 314 to reduce thermal conduction between the two plates as described above.

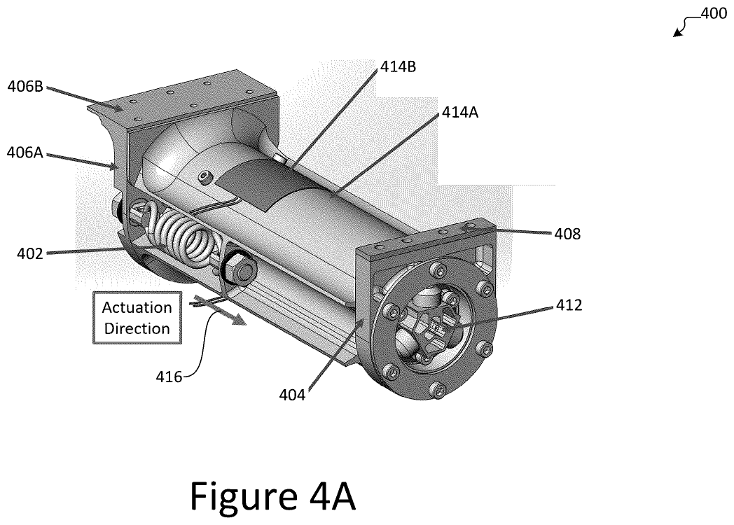

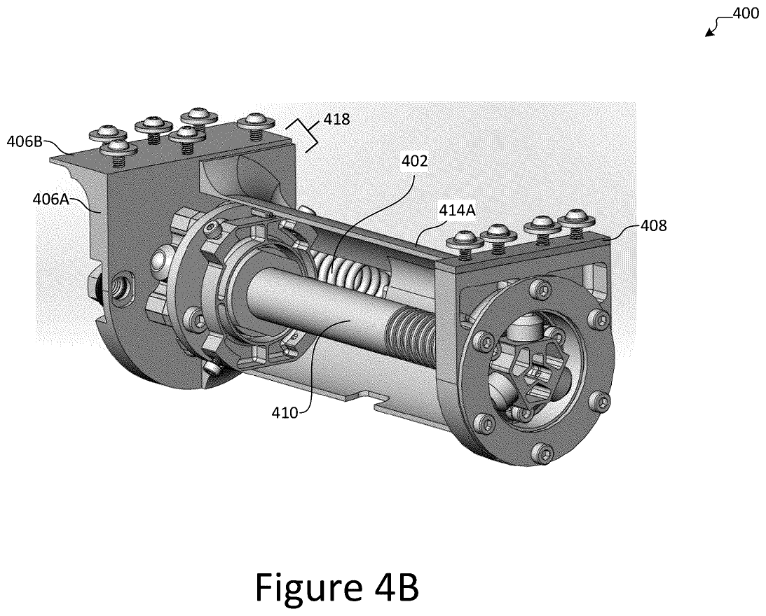

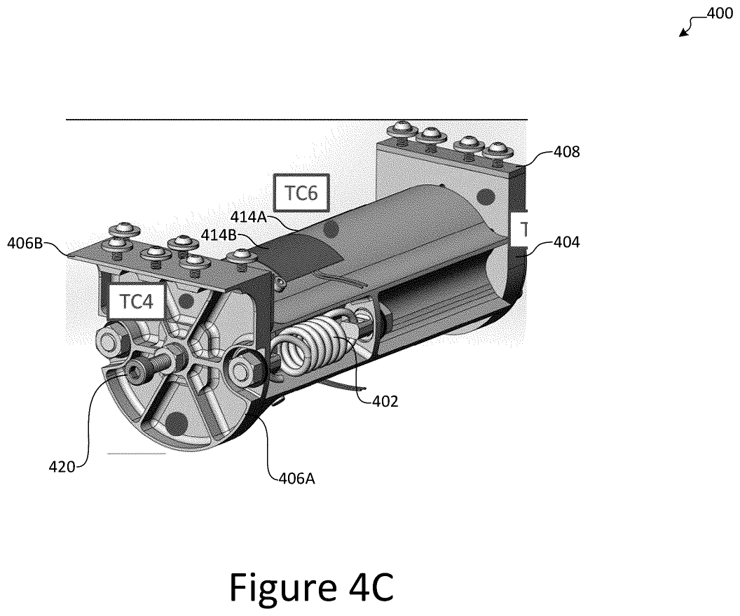

FIGS. 4A-4C illustrate another example thermal switch assembly 400 according to aspects described herein. As illustrated, thermal switch assembly 400 includes preload spring 402, cold plate 406A, radiator interface 406B, piezoelectric actuator 410 (FIG. 4B), hot plate 414A, and heater 414B. Aspects of thermal switch assembly 400 may be similar to those discussed above with respect to thermal switch assemblies 204 and 300 of FIGS. 2 and 3A-3B, respectively, and are therefore not necessarily rediscussed in detail below. For example, aspects of cold plate 406A and hot plate 414A may be similar to plates 208, 210, 306, and/or 314, while aspects of preload spring 402 and piezoelectric actuator 410 may be similar to preload springs 302 and piezoelectric actuators 310, respectively.

Radiator interface 406B of cold plate 406A may be mechanically coupled to a radiator and/or any of a variety of other elements of a thermal management system in other examples. Accordingly, thermal switch assembly 400 permits heat transfer from a heat source (e.g., heater 414B) via hot plate 414A to a heat sink (e.g., coupled to radiator interface 406B) via cold plate 406A. Heater 414B may be mechanically coupled to hot plate 414A using a thermal epoxy or other thermal interface material. Heater 414B is provided as an example heat source and it will be appreciated that, in other examples, any of a variety of additional or alternative heat sources may be used, such as an avionics box, a heat-producing component, and/or others. Preload spring 402 may cause thermal switch assembly 400 to be in a closed state absent actuation of piezoelectric actuator 410.

When piezoelectric actuator 410 is extended (e.g., as a result of applying a voltage), gap 418 (FIG. 4B) is formed between hot plate 414A and cold plate 406A, thereby opening thermal switch assembly 400. Arrow 416 (FIG. 4A) is provided to illustrate the associated actuation direction. Support bracket 404 supports thermal switch assembly 400, where insulation 408 may reduce conductive heat transfer between thermal switch assembly 400 and hardware to which assembly 400 is coupled. In examples, hot plate 414A moves toward support bracket 404 (e.g., along an axis parallel to actuation direction 416) when actuated, while support bracket 404 may remain stationary. In examples, positioning screw 420 (FIG. 4C) is used to control the offset of piezoelectric actuator 410 within thermal switch assembly 400 (e.g., along the axis parallel to actuation direction 416), as different piezoelectric actuators may exhibit different characteristics, such that the gap that forms when actuated is controllable accordingly.

Thermal switch assembly 400 is further illustrated as comprising component 412 (FIG. 4A), which may restrict movement (e.g., radially) due to vibration, for example during launch. In examples, component 412 includes one or more ball bearings that reduce friction that is introduced by vibration. In some examples, a ball bearing of component 412 is made of a relatively low-conductivity material and may thus have a high thermal resistance so as to reduce parasitic loss (e.g., from hot plate 414A through the support bracket 404).

While thermal switch assembly 400 is described in the context of cold plate 406A and hot plate 414A, it will be appreciated that, in other examples, such elements may instead act as a hot plate and a cold plate, respectively. Thus, a thermal switch assembly according to aspects described herein may be used in a situation where a “hot plate” of the thermal switch assembly is actually colder than the “cold plate,” while still retaining the disclosed functionality. Further, while FIGS. 3A-3B and 4A-4C have been described with reference to example actuation mechanisms, it will be appreciated that any of a variety of additional or alternative actuation mechanisms may be used in other examples.

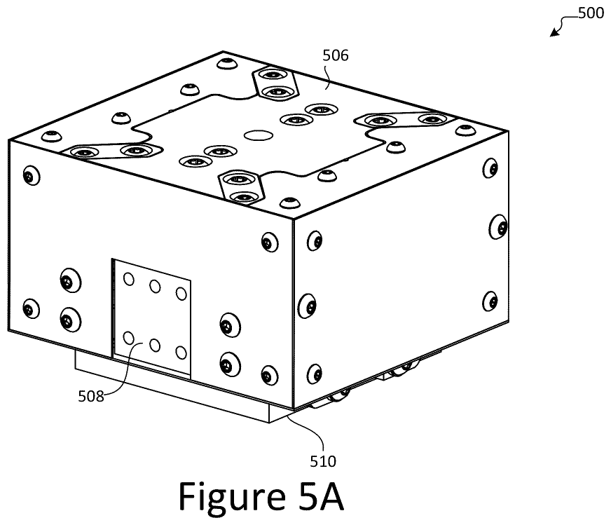

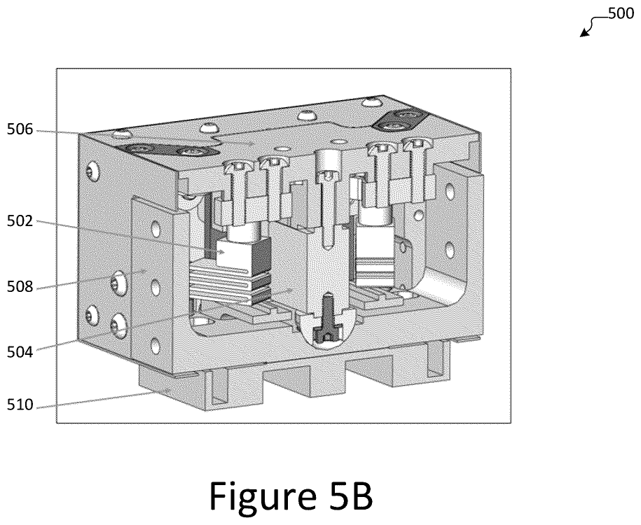

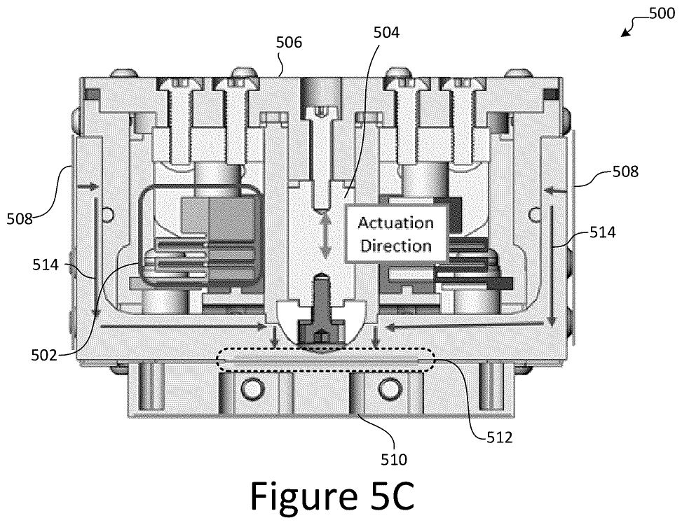

FIGS. 5A-5C illustrate another example thermal switch assembly 500 according to aspects described herein. As illustrated, thermal switch assembly 500 includes springs 502, piezoelectric actuator 504, contact surface 508, and contact surface 510. Aspects of thermal switch assembly 500 may be similar to those discussed above with respect to thermal switch assemblies 204, 300, and 400 of FIGS. 2, 3A-3B, and 4A-4C, respectively, and are therefore not necessarily rediscussed in detail below. For example, aspects of contact surfaces 508 and 510 may be similar to plates 208, 210, 306, 314, 406A and/or 414A, while aspects of springs 502 and piezoelectric actuator 504 may be similar to preload springs 302, 402 and piezoelectric actuators 310, 410, respectively. In examples, contact surface 508 is a hot plate and contact surface 510 is a cold plate, or vice versa.

Thermal switch assembly 500 further includes radiative interface 506, which is used to regulate the temperature of piezoelectric actuator 504. Thus, piezoelectric actuator 504 and radiative surface 506 may be mechanically coupled so as to promote heat transfer therebetween. With reference to FIG. 5C, arrows 514 are provided to illustrate an example of heat transfer between contact surfaces 508 and 510. As is evident in FIG. 5C, thermal switch assembly 500 illustrates an example in which multiple contact surfaces 508 are used to facilitate heat transfer to/from contact surface 510. In other examples, heat transfer is reversed.

Dashed oval 512 indicates the switchable contact surface of thermal switch assembly 500, such that heat transfer between contact surface 508 and contact surface 510 may be reduced or interrupted by introducing a gap between the switchable contact surface. In examples, thermal switch assembly is in an open state when unpowered, such that piezoelectric actuator 504 produces force that overcomes springs 502 and causes contact at the switchable contact surface when powered, thereby causing thermal switch assembly 500 to enter a closed state.

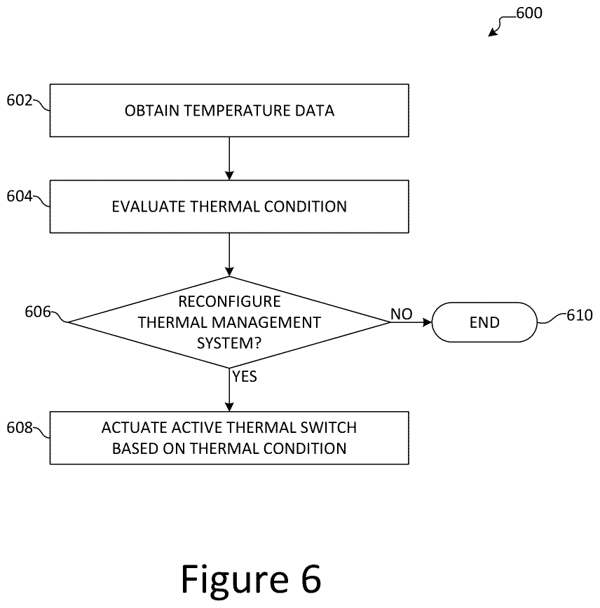

FIG. 6 illustrates an overview of an example method 600 for controlling a thermal switch assembly according to aspects described herein. In an example, aspects of method 600 are performed by a thermal manager, such as thermal manager 114 or thermal manager 214 in FIG. 1 or 2, respectively.

As illustrated, method 600 begins at operation 602, where temperature data is received. For example, the temperature data may relate to a condition of an environment and/or a condition of a system to which a thermal switch assembly is coupled. In examples, operation 602 comprises obtaining temperature data from one or more sensors (e.g., sensors 110 in FIG. 1). In some instances, operation 602 comprises obtaining a current temperature and/or generating an expected or forecasted temperature (e.g., as may be determined using the sensor data and/or one or more models). For example, operation 602 comprises determining a temperature for hardware of a system, such that the temperature of the hardware is being managed to be within an operating range.

At operation 604, a thermal condition (e.g., as may be indicated by the obtained temperature data) is evaluated. For example, a temperature range associated with one or more components is evaluated to determine whether the temperature data indicates a temperate that is outside of the temperature range. In examples, operation 604 additionally or alternatively evaluates one or more other systems, as may be the case when heat is transferred between systems (e.g., of vehicle 100, as discussed above).

Accordingly, at determination 606, it is determined whether to reconfigure the thermal management system. For example, if the thermal data that was obtained at operation 602 was determined to exceed a threshold at operation 604 (e.g., corresponding to an operating range, for an actual or a forecasted temperature), it may be determined to reconfigure the thermal management system accordingly. While example conditions and determinations are described, it will be appreciated that additional or alternative conditions and associated determinations may be used in other examples. Further, while aspects are described with respect to autonomous temperature control, it will be appreciated that, in other examples, an indication of a determined condition and/or thermal configuration may be provided for display to a user, such that a command to reconfigure the thermal management system may be received in response. If it is determined not to reconfigure the thermal management system, flow branches “NO” and ends at operation 610.

If it is determined to reconfigure the thermal management system, flow branches “YES” to operation 608, where an active thermal switch is actuated based on the thermal condition. For example, the active thermal switch may be opened, closed, or reconfigured to change the degree to which heat energy is transferred across the active thermal switch. In examples, operation 608 comprises applying a voltage to an actuator, thereby causing the actuator to move plates closer together or father apart, depending on the configuration of the thermal switch. As another example, operation 608 comprises reducing or removing a voltage from an actuator, thereby causing the actuator to no longer overcome a preload force, such that plates move farther apart or closer together depending on the configuration of the thermal switch.

In examples, flow terminates at operation 608. In other examples, method 600 loops between operations 602-610, thereby controlling one or more active thermal switches to manage the thermal properties accordingly.

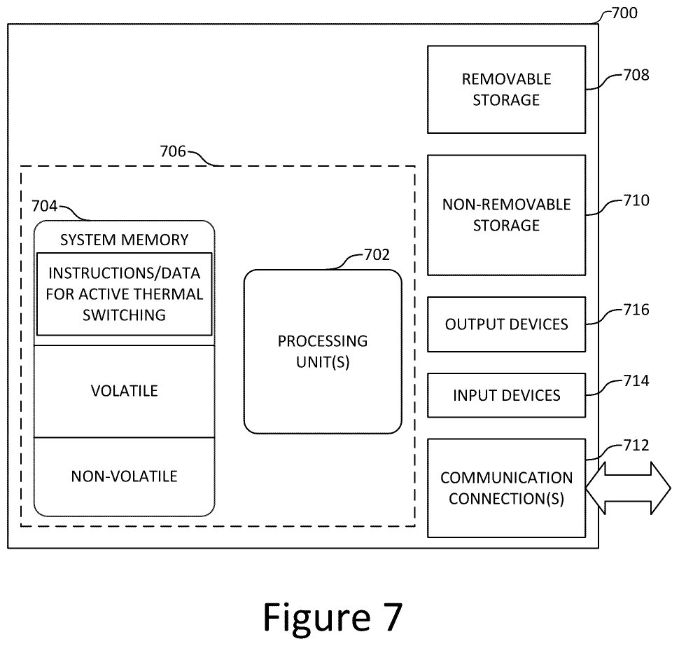

FIG. 7 illustrates an example of a suitable computing environment 700 in which one or more of the present embodiments may be implemented. For example, aspects of computing environment 700 may be used by a controller, such as vehicle controller 102 in FIG. 1. This is only one example of a suitable computing environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, computing environment 700 typically may include at least one processing unit 702 and memory 704. Depending on the exact configuration and type of computing device, memory 704 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 7 by dashed line 706. Further, environment 700 may also include storage devices (removable, 708, and/or non-removable, 710) including, but not limited to, magnetic or optical disks or tape. Similarly, environment 700 may also have input device(s) 714 such as a keyboard, mouse, pen, voice input, etc. and/or output device(s) 716 such as a display, speakers, printer, etc. Also included in the environment may be one or more communication connections, 712, such as LAN, WAN, point to point, etc.

Computing environment 700 may include at least some form of computer readable media. The computer readable media may be any available media that can be accessed by processing unit 702 or other devices comprising the computing environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The computing environment 700 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets, and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 704. While executing on the processing unit 702, program modules (e.g., applications, Input/Output (I/O) management, and other utilities) may perform processes including, but not limited to, one or more of the stages of the operational methods described herein.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing environment 700 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A thermal switch assembly, comprising:
a first plate configured to be mechanically coupled to a first instance of hardware;
a second plate configured to be mechanically coupled to a second instance of hardware; and
an actuator mechanically coupled to at least one of the first plate and the second plate, wherein:
in a first configuration, a gap is formed between the first plate and the second plate; and
in a second configuration, at least a part of the first plate contacts at least a part of the second plate, thereby permitting heat transfer between the first plate and the second plate.

2. The thermal switch assembly of claim 1, wherein the actuator includes one of a piezoelectric actuator, a linear actuator, a lead/ball screw actuator, a mechanical cam actuator, or a chain and sprocket assembly.

3. The thermal switch assembly of claim 1, wherein the actuator is a first actuator and the thermal switch assembly further comprises a second actuator.

4. The thermal switch assembly of claim 1, wherein the thermal switch assembly further comprises a set of fasteners that couple the first plate to the first plate, wherein each fastener has an associated preload spring.

5. The thermal switch assembly of claim 4, wherein the actuator is configured to overcome a preload force of the preload springs in the first configuration.

6. The thermal switch assembly of claim 4, wherein the actuator is configured to overcome a preload force of the preload springs in the second configuration.

7. The thermal switch assembly of claim 1, wherein a surface of the part of the first plate and a surface of the second plate each include a coating to reduce emissivity between the first plate and the second plate.

8. The thermal switch assembly of claim 1, further comprising:
a thermal manager electrically coupled to the actuator, comprising:
a processor; and
a memory storing instructions that, when executed by the processor, cause the thermal manager to perform a set of operations, comprising:
evaluating an environment condition to determine a configuration for the thermal switch assembly; and
based on the determined configuration for the thermal switch assembly, controlling the actuator, thereby causing the actuator to be in either the first configuration or the second configuration.

9. The thermal switch assembly of claim 8, wherein determining the configuration for the thermal switch assembly comprises evaluating at least one of:
a temperature of the thermal switch assembly;
a temperature corresponding to the first instance of hardware; or
a temperature corresponding to the second instance of hardware.

10. The thermal switch assembly of claim 1, wherein the actuator is insulated from at least one of the first plate or the second plate.

11. A system, comprising:
a thermal manager;
a thermal switch assembly, the thermal switch assembly comprising:
a first plate configured to be mechanically coupled to a first instance of hardware;
a second plate configured to be mechanically coupled to a second instance of hardware; and
an actuator controlled by the thermal manager, the actuator mechanically coupled to at least one of the first plate and the second plate, wherein:
in a first configuration, a gap is formed between the first plate and the second plate; and
in a second configuration, at least a part of the first plate contacts at least a part of the second plate, thereby permitting heat transfer between the first plate and the second plate.

12. The system of claim 11, wherein the actuator includes one of a piezoelectric actuator, a linear actuator, a lead/ball screw actuator, a mechanical cam actuator, or a chain and sprocket assembly.

13. The system of claim 11, wherein the actuator is a first actuator and the thermal switch assembly further comprises a second actuator.

14. The system of claim 11, wherein the thermal switch assembly further comprises a set of fasteners that couple the first plate to the first plate, wherein each fastener has an associated preload spring.

15. The system of claim 14, wherein the actuator is configured to overcome a preload force of the preload springs in the first configuration.

16. The system of claim 14, wherein the actuator is configured to overcome a preload force of the preload springs in the second configuration.

17. The system of claim 11, wherein a surface of the part of the first plate and a surface of the second plate each include a coating to reduce emissivity between the first plate and the second plate.

18. The system of claim 11, wherein the thermal manager comprises:
a processor; and
a memory storing instructions that, when executed by the processor, cause the thermal manager to perform a set of operations, comprising:
evaluating an environment condition to determine a configuration for the thermal switch assembly; and
based on the determined configuration for the thermal switch assembly,
controlling the actuator, thereby causing the actuator to be in either the first configuration or the second configuration.

19. A method for controlling a thermal switch assembly having a first plate, a second plate, and an actuator mechanically coupled to at least one of the first plate and the second plate, the method comprising:
evaluating an environment condition associated with the thermal switch assembly to determine a configuration for the thermal switch assembly;
actuating, based on the determined configuration for the thermal switch assembly, the actuator to be in either a first configuration or a second configuration, wherein:
in the first configuration, a gap is formed between the first plate and the second plate; and
in the second configuration, at least a part of the first plate contacts at least a part of the second plate, thereby permitting heat transfer between the first plate and the second plate.

20. The method of claim 19, wherein the evaluating an environment condition associated with the thermal switch assembly to determine a configuration for the thermal switch assembly comprises evaluating at least one selected from the group comprising:
a temperature of the thermal switch assembly;
a temperature corresponding to a first instance of hardware coupled to the first plate; and
a temperature corresponding to a second instance of hardware coupled to the second plate.
